(19) United States
(12) Patent Application Publication
(10) Pub. No.: US 2006/0022013 A1
(43) Pub. Date: Feb. 2, 2006

(54) Gas charge setting tool

(76) Inventor: Paul Gaudron, Stamford, CT (US)

Correspondence Address: CANTOR COLBURN, LLP, 55 GRIFFIN ROAD SOUTH, BLOOMFIELD, CT, 06002, US

(21) Appl. No.: 11/185,329

(22) Filed: Jul. 20, 2005

Related U.S. Application Data
(60) Provisional application No. 60/589,891, filed on Jul. 20, 2004.

(51) Int. Cl. B25C 1/14

(52) U.S. Cl. 227/10; 227/130

(57) ABSTRACT

A setting tool including a body and a fuel canister in operable communication with the body. The canister includes a metering valve therein which may be put in operable communication with a manifold itself in operable communication with the body. The setting tool further includes a nose in operable communication with the canister, the nose capable of urging the canister toward the manifold to cause a metered volume of fuel to exit the canister and flow into the manifold. A method for charging a setting tool with a fuel charge. The method includes urging a fuel canister against a manifold in a setting tool, receiving in the manifold a metered fuel charge, and conveying the metered fuel charge to a combustion chamber of the setting tool.

### CROSS-REFERENCE TO RELATED APPLICATIONS

This application claims the benefit of an earlier filing date to U.S. Ser. No. 60/589,891, filed on Jul. 20, 2004, the entire contents of which is incorporated herein by reference.

### BACKGROUND

Powered setting tools exist in many forms such as pneumatic, electric, powder, fluid fuel, etc. The following disclosure relates to fluid fuel based setting tools and particularly those employing on board fluid fuel canisters.

Prior art fuel canister based setting tools operate by causing a metered volume of fuel to enter a combustion chamber in the setting tool whereafter an ignition of the fuel causes the setting tool to discharge a fastener into a work piece.

Metering of fuel in these devices is caused by 1) snapping an external metering valve onto a top of a fuel canister which actuates the canister non-metered valve and becomes the valve for the system and 2) causing the external valve to meter. The external metering valve (commercially available from Forum Molding Stamford Conn.) meters an appropriate amount of fuel into the combustion chamber of the tool. Such external metering valves are expensive in a relative sense. Therefore, a means of metering a fuel charge without the need for an external metering valve would be of benefit to the manufacturers of such fuel canister based setting tools in the form of reduced cost due to omission of the external metering valve. Heretofore however it has not been possible to eliminate the external metering valve

### SUMMARY

Disclosed herein is a setting tool including a body and a fuel canister in operable communication with the body. The canister includes a metering valve therein which may be put in operable communication with a manifold itself in operable communication with the body. The setting tool further includes a nose in operable communication with the canister, the nose capable of urging the canister toward the manifold to cause a metered volume of fuel to exit the canister and flow into the manifold.

Further disclosed herein is a method for charging a setting tool with a fuel charge. The method includes urging a fuel canister against a manifold in a setting tool, receiving in the manifold a metered fuel charge, and conveying the metered fuel charge to a combustion chamber of the setting tool.

### BRIEF DESCRIPTION OF THE DRAWINGS

Referring now to the drawings wherein like elements are numbered alike in the several Figures:

FIG. 1 is a cross sectional view of a setting tool in an idle condition;

FIG. 2 is a cross sectional view of a setting tool in a ready-to-dispense condition;

FIG. 3 is another cross sectional view of another embodiment in an unactuated condition;

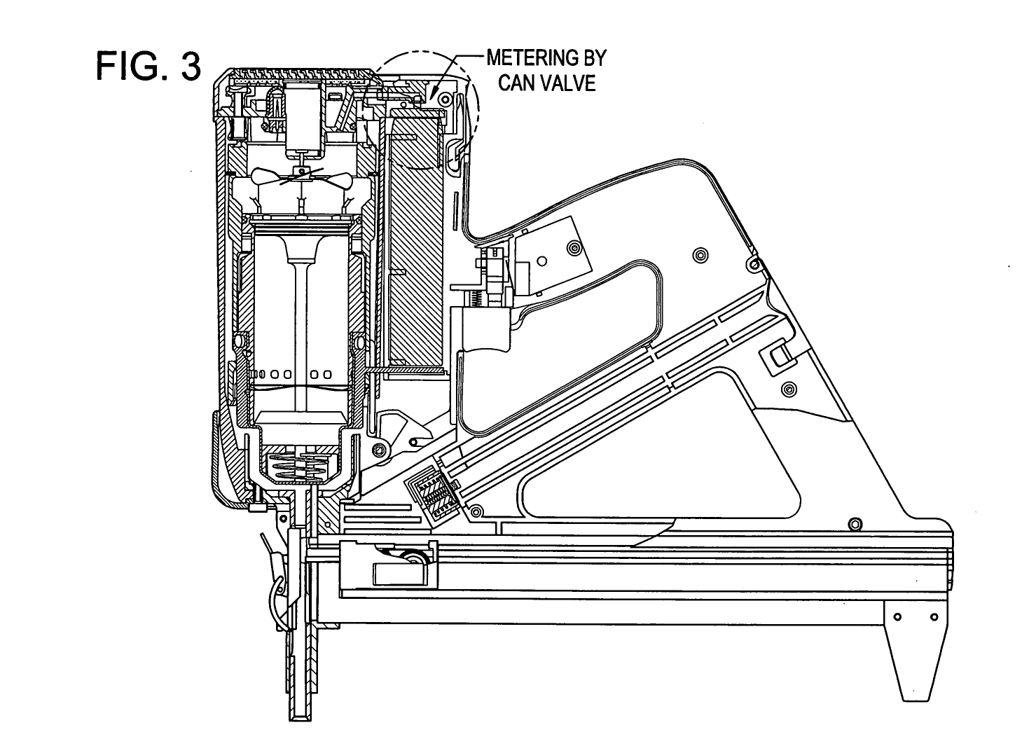

FIG. 4 is the view of FIG. 3 in an actuated condition;

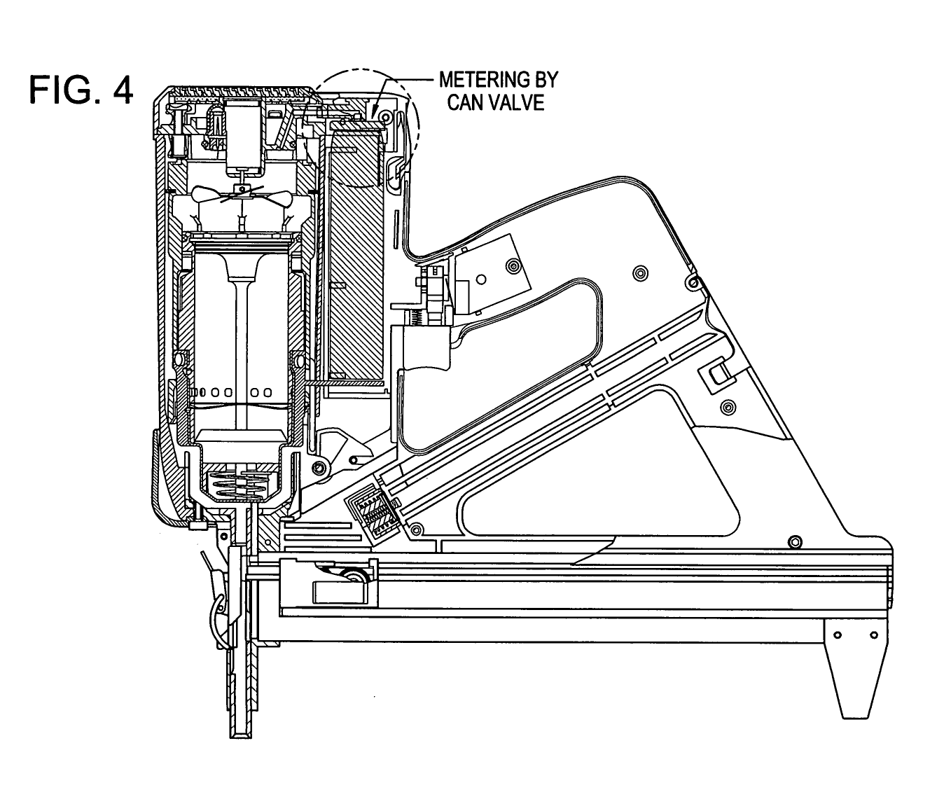

FIG. 5 is another cross sectional view of the embodiment of FIG. 3 in an unactuated condition;

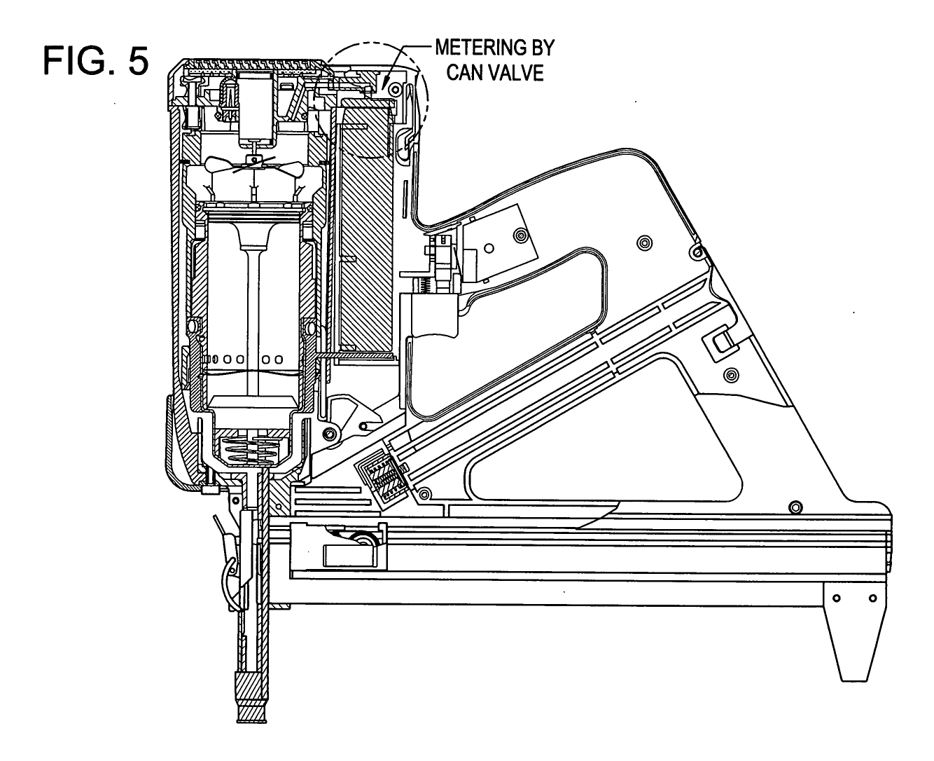

FIG. 6 is another view of the FIG. 3 embodiment in an actuated condition; and

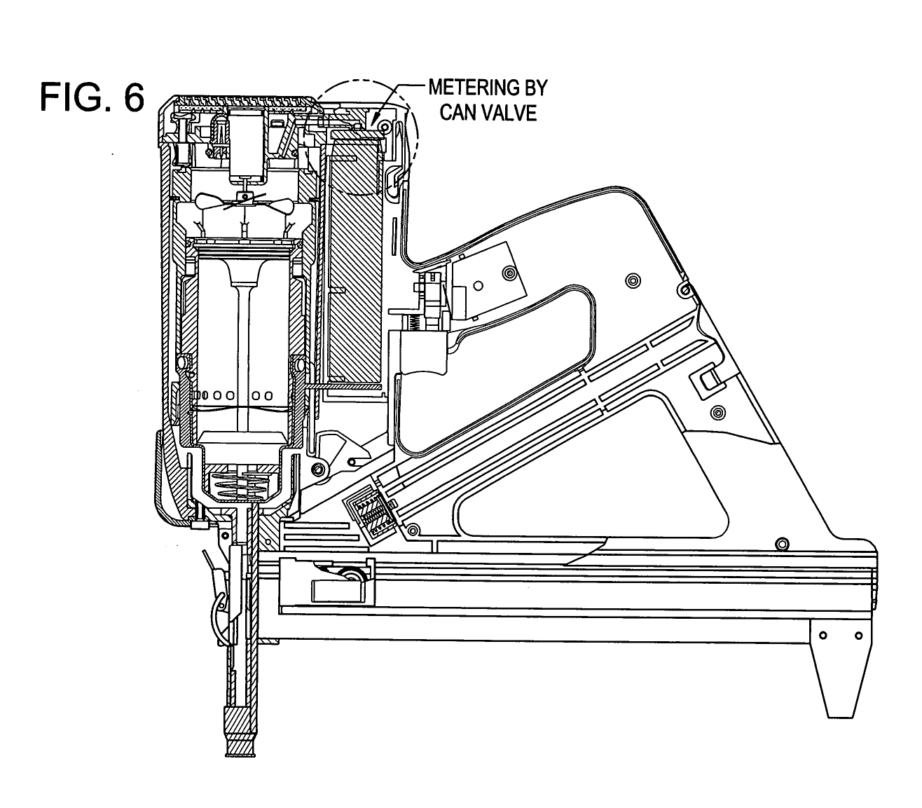

FIG. 7 is a schematic view of the cage, probe and nose of the setting tool illustrated apart from the rest of the setting tool for clarity.

FIG. 8 is a perspective view of the cage, probe and nose as illustrated in FIG. 7.

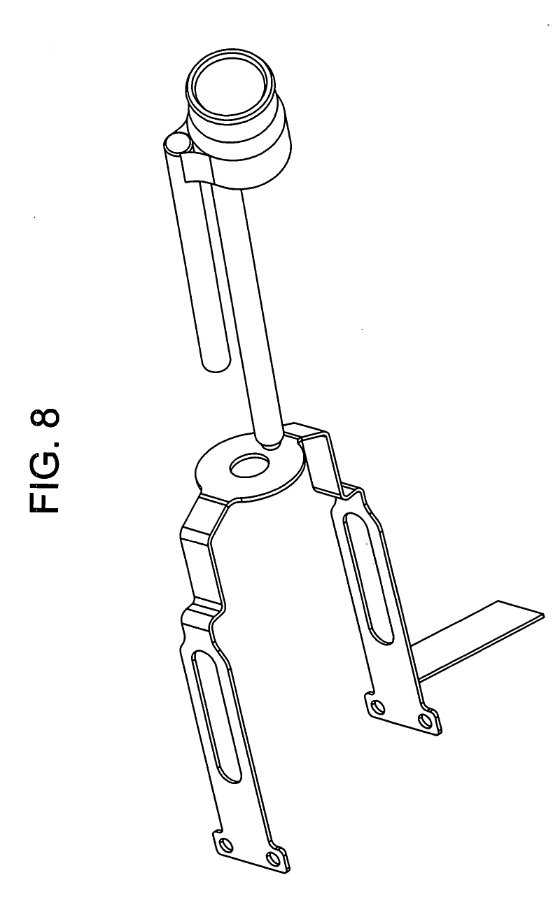

### DETAILED DESCRIPTION

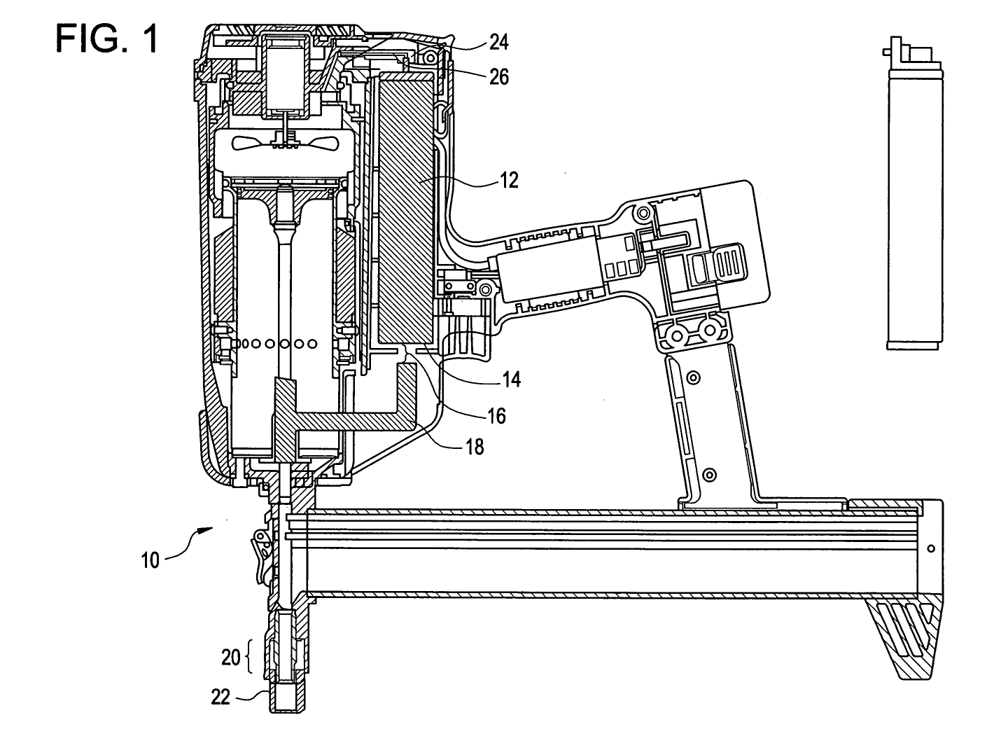

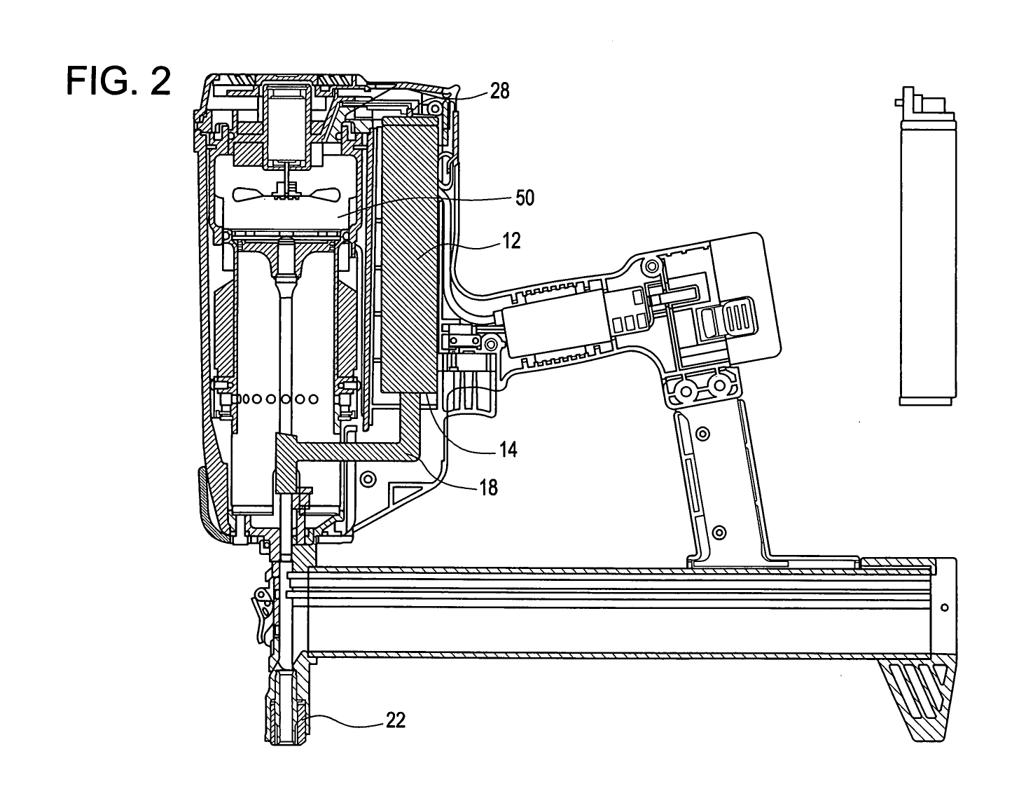

Many of the components of a fuel canister based setting tool such as 10 in FIGS. 1 and 2 are known from commercially available products. The setting tool illustrated in FIGS. 1 and 2 is a commercially available product known as “Trak-it”, by Powers Fasteners, Inc. In large part there is no need to discuss or identify these components, which are therefore pictured but not described. Some of the prior art components are, nevertheless, identified but only those that are germain to an understanding of the componentry enabling the elimination of the separate metering component, which is the object of this disclosure.

Referring to FIGS. 1 and 2 simultaneously, one of ordinary skill in the art will appreciate the mechanism taught herein. FIGS. 1 and 2 are cross sectional views of the setting tool 10 in sequential conditions of activation. FIG. 1 illustrates the setting tool 10 in a resting condition i.e., not in contact with a workpiece. FIG. 2 illustrates the same setting tool in cross section in a condition where the tool has been urged against a work surface. The positional distinctions of components of setting tool 10 between FIGS. 1 and 2, further described herein below, demonstrate the concept intended to be disclosed herein.

Referring to FIG. 1, 3, and 5, the tool 10 is in an idle position. Canister 12 is located within tool 10 and is in a non-actuated condition. At a bottom end 14 of canister 12 a space 16 is illustrated between bottom 14 and an activating arm 18. The space 16 is related to, but of different (shorter) total length than a stroke length 20 of a nose 22. Space 16 is shorter in activation length than stroke length 20 by an amount sufficient to cause arm 18 to contact bottom 14 and then urge canister 12 upwardly by an amount sufficient to complete the designed-in intended stroke of the canister for causing a metering event to take place. The intended stroke of the canister will be completed before exhausting the stroke length 20. Stroke length 20 is to be traversed by arm 18 due to movement of the nose 22. Nose 22 is stroked by urging of the setting tool 10 against a work surface (not shown) where physical contact is made between nose 22 and the work surface (not shown).

In one embodiment hereof the nose 22 is directly physically connected to arm 18 to ensure a direct transfer of the movement of nose 22 to arm 18. It will be appreciated however that other arrangements are possible where movements of arm 18 (and thereby canister 12) are not by direct mechanical communication or connection but may employ indirect communication, the goal being to cause substantially linear movement of canister 12.

Canister 12 includes an internal metering valve fluid conveyingly connected to an exit nipple 28 and thereby will meter a pre-selected volume of fluid fuel to a manifold 24 each time nose 22 is urged sufficiently through its stroke length 20. Such metering valves are commercially available and are common in such readily known dispensing units as women's hair products, shaving gel, aerosol dispensing cans, etc. Manifold 20 need merely contain a fluid flow channel 26 and overall geometric configuration sufficient to fit within the setting tool 10. It is important to note that manifold 24 replaces the external metering valve from prior art setting tools. The external metering valves are themselves metering devices and are relatively costly to produce. By configuring the setting tool as is done in this disclosure, the external metering valve can be eliminated thus reducing cost for the overall setting tool 10.

Referring now to FIG. 2, 4 and 6, the setting tool 10 is illustrated in the ready-to-discharge condition. The nose 22 is illustrated as compressed into the body of setting tool 10 to its entire stroke 20. This in turn has caused arm 18 to move closer and into contact with canister bottom 14. Toward the end of stroke 20, arm 18 makes contact with bottom 14 and will then urge canister 12 toward manifold 24 for the duration of stroke 20. Since manifold 24 is a fixed component of setting tool 10, nipple 28 of canister 12 is urged against manifold 24, which depresses nipple 28, thereby actuating the valve (not shown). The Valve will thus emit a metered volume of fuel into flow channel 26 for conveyance to a combustion chamber 30.

Upon release of the urging force on the setting tool 10 into the workpiece, the nose 22 will reemerge from the setting tool 10 bringing with it the arm 18 and allowing canister 12 to return to its ready position whereafter it is capable of issuing another metered volume of fuel based upon an additional movement toward the manifold 24 occasioned by the subsequent urging of setting tool 10 against a work surface as described above.

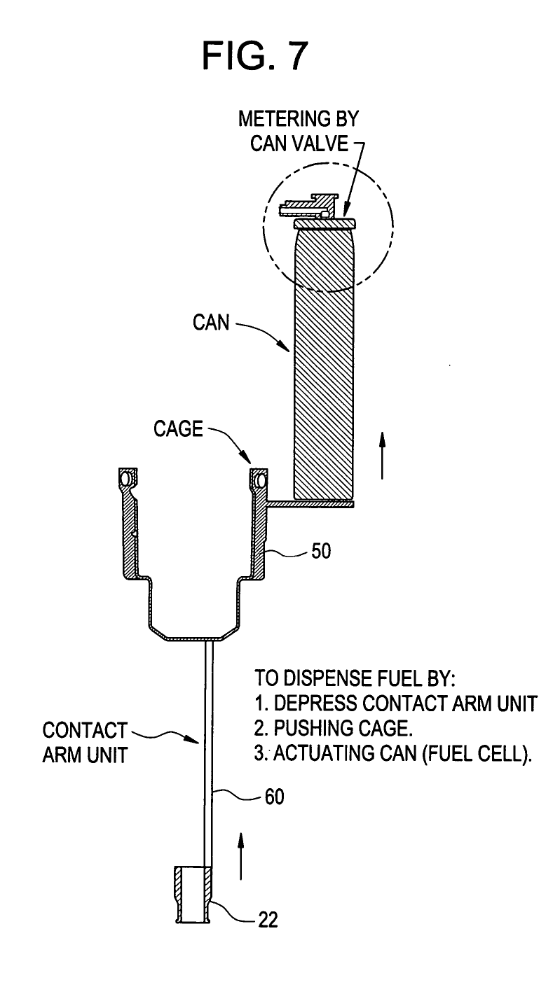

Referring to FIG. 7, a cage 50, probe 60 and the nose 22 are illustrated removed from the balance of the tool for clarity.

The foregoing disclosure benefits the art in that it reduces cost of the setting tool while retaining all of the benefits of the prior art models.

While embodiments of the invention are described with reference to the exemplary embodiments, it will be understood by those skilled in the art that various changes may be made and equivalence may be substituted for elements thereof without departing from the scope of the invention. In addition, many modifications may be made to the teachings of the invention to adapt to a particular situation without departing from the scope thereof. Therefore, it is intended that the invention not be limited to the embodiment disclosed for carrying out this invention, but that the invention includes all embodiments falling with the scope of the intended claims. Moreover, the use of the term's first, second, etc. does not denote any order of importance, but rather the term's first, second, etc. are used to distinguish one element from another. Furthermore, the use of the terms a, an, etc. do not denote a limitation of quantity, but rather denote the presence of at least one of the referenced items.

1. A setting tool comprising:
a body;
a manifold in operable communication with the body;
a fuel canister in operable communication with the body, the canister including a metering valve embodied therein, the valve being engagable with the manifold; and
a nose in operable communication with the canister.

2. The setting tool as claimed in claim 1, wherein the nose is movable within the body in response to contact of the nose against a separate surface.

3. The setting tool as claimed in claim 2, wherein the movement of the nose directly causes urging of the canister toward the manifold to cause a metered volume of fuel to exit the canister and flow into the manifold.

4. The setting tool as claimed in claim 1, wherein the canister meters a volume of fuel upon compression of an exit nipple.

5. The setting tool as claims in claim 1, wherein the nose is in operable communication with an arm so that actuation of the nose causes movement of the canister.

6. A method for charging a setting tool with a fuel charge comprising:
urging a fuel canister against a manifold in a setting tool;
receiving in the manifold a metered fuel charge; and
conveying the metered fuel charge to a combustion chamber of the setting tool.

7. The method as claimed in claim 6, wherein the urging is by compressing a nose of the setting tool against a work surface, the nose being in operable communication with the fuel canister.

8. The method as claimed in claim 6, wherein the conveying is passive.
